(19) United States
(12) Patent Application Publication
(10) Pub. No.: US 2012/0312130 A1
(43) Pub. Date: Dec. 13, 2012

(54) FASTENERS AND FASTENING SYSTEMS

(76) Inventor: Jason Bauer, Queen Creek, AZ (US)

(21) Appl. No.: 13/155,701

(22) Filed: Jun. 8, 2011

(51) Int. Cl. F16B 23/00; B25B 23/00; F16B 31/00; B25B 15/00

(52) U.S. Cl. 81/461; 81/436; 411/407; 411/2

(57) ABSTRACT

A system includes a fastener and a driving tool configured to mate with the fastener. The fastener includes a driving portion having an upper face, a bottom face, and a side wall extending between the upper and bottom faces. Recessed sections extend into the driving portion from the upper face. Each recessed section includes a first wall in spaced relation to a second wall. At least one of the first and second walls is angled to form a wedge-shaped undercut underlying the upper face of the driving portion. The driving tool includes a raised portion extending from a floor of the driving tool. The raised portion has third and forth walls, and at least one of the third and fourth walls is angled relative to the floor to form a wedge-shaped extension section. The extension section engages with the undercut to interlock the driving tool with the fastener during installation and/or removal.

### TECHNICAL FIELD OF THE INVENTION

The present invention relates generally to fasteners and fastening systems. More specifically, the present invention relates to fasteners with improved resistance to damage during installation and/or removal.

### BACKGROUND OF THE INVENTION

Fasteners, such as bolts, screws, nuts, and the like are used in a wide variety of applications to mechanically join or affix two or more objects together. Typically, a threaded bolt or screw includes a threaded shank and a driving portion, usually referred to as a head. Whereas, the driving portion of a nut is a suitably shaped outer periphery of the nut. In either instance, a driving tool such as a wrench, socket, screwdriver, and so forth engages with the driving portion to apply torque to the fastener.

The application of torque to the driving portion of a fastener can cause damage to the fastener so that it becomes unusable. For example, a driving tool, such as an screwdriver may cam out, i.e., slip out, of the head of a screw that is being driven once the torque required to turn the screw exceeds a certain amount. Frequently, the process of camming out damages the head of the fastener. That is, the head may “strip out” so that torque can no longer be applied to the head. By way of another example, the outer periphery of the fastener may become damaged by the driving tool so that the tool no longer securely engages with the driving portion of the fastener.

This damage can occur if the tool is not properly seated when torque is applied. Or, it can occur if the fastener is over-tightened or if the threads become damaged, such as by galling, fusing, or corroding. Typically, the fastener is in threaded engagement when the driving portion becomes unusable, so much time is lost removing the fastener. Yet another problem caused by improper seating, damaged threads, or over-tightening is that they can cause the tool to break concurrently with, or instead of, stripping out the head.

### BRIEF DESCRIPTION OF THE DRAWINGS

A more complete understanding of the present invention may be derived by referring to the detailed description and claims when considered in connection with the Figures, wherein like reference numbers refer to similar items throughout the Figures, and:

FIG. 1 shows a perspective view of a fastener in accordance with an embodiment;

FIG. 2 shows a side view of a driving tool engaged with a driving portion of the fastener of FIG. 1;

FIG. 3 shows a perspective view of a fastener in accordance with another embodiment;

FIG. 4 shows a perspective view of a fastener in accordance with another embodiment;

FIG. 5 shows a perspective view of a fastener in accordance with another embodiment;

FIG. 6 shows a perspective view of a fastener in accordance with another embodiment;

FIG. 7 shows a perspective view of a driving tool configured to engage with the fastener of FIG. 5;

FIG. 8 shows an enlarged partial side view of the driving tool of FIG. 7 engaged with the fastener of FIG. 5;

FIG. 9 shows a partial perspective view of a driving tool in the form of a socket in accordance with another embodiment;

FIG. 10 shows a side view of the socket of FIG. 9 engaged with a ratchet type wrench handle;

FIG. 11 shows a perspective view of a fastener in accordance with another embodiment;

FIG. 12 shows a top view of the fastener of FIG. 11;

FIG. 13 shows a perspective view of a fastener in accordance with another embodiment;

FIG. 14 shows a perspective view of a driving tool configured to engage with the fastener of FIG. 10;

FIG. 15 shows a partial perspective view of a fastener in accordance with another embodiment;

FIG. 16 shows a perspective view of a fastener in accordance with another embodiment;

FIG. 17 shows a perspective view of a fastener in accordance with yet another embodiment;

FIG. 18 shows a partial perspective view of a fastener in accordance with another embodiment;

FIG. 19 shows a perspective view of a fastener in accordance with another embodiment; and

FIG. 20 shows a partial perspective view of a fastener in accordance with another embodiment.

### DETAILED DESCRIPTION

Fasteners, such as bolts, screws, nuts, and the like are often stripped out during installation and even more commonly during removal. The fasteners typically strip because the engagement area between the driving tool and the fastener has a lower torque value than the hardness value of the material. This is particularly troublesome during fastener removal when damage to the driving portion or head of the fastener significantly complicates its removal.

Additionally, fasteners such as screws require an opposite force during the removal process than the intended direction of travel of the screw. For example, a user is compelled to apply axial force into the head of a screw to ensure secure engagement between the head of the fastener and the driving tool, while simultaneously applying torque to the screw so that it can loosen or back out in a direction opposite to the axial force being applied to hold the driving tool engaged with the fastener. This slows down and hinders extraction, as well as increases the likelihood that the head may be damaged during its extraction.

Embodiments described below entail fasteners, such as bolts, screws, and nuts, each of which includes a wedge-shaped undercut feature. A driving tool is configured to engage with, or mate with, a corresponding wedge-shaped undercut feature of a particular fastener. The engagement of the driving tool with the fastener causes the driving tool and the driving portion of the fastener to temporarily interlock. This interlocking feature reduces the probability of stripping, increases the amount of torque that may be applied, can be implemented in low profile applications, can be used for security fastener applications, and so forth.

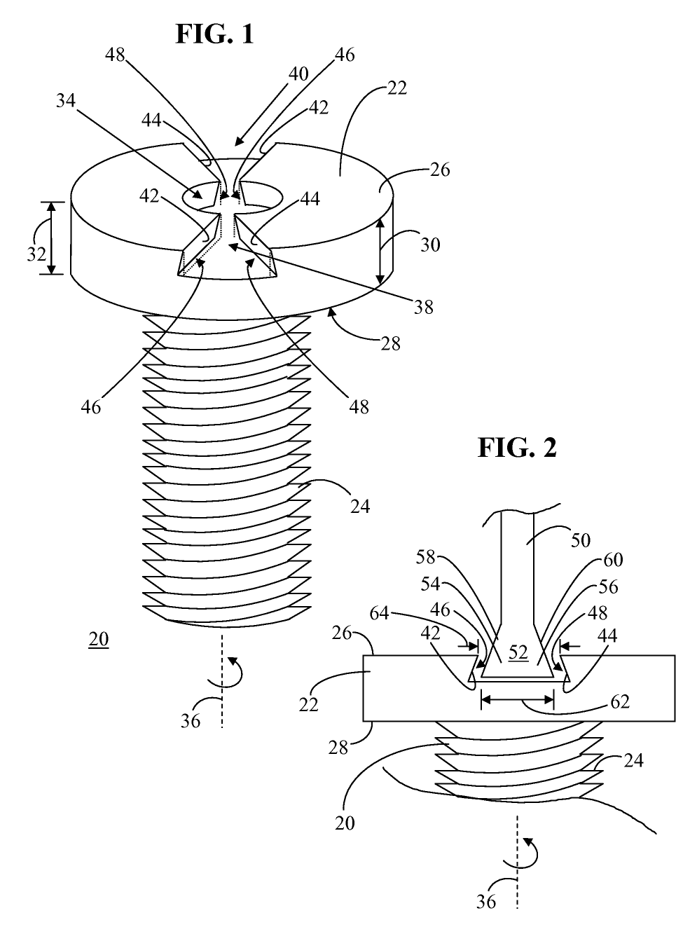

FIG. 1 shows a perspective view of a fastener 20 in accordance with an embodiment. In the illustrated embodiment, fastener 20 may be a threaded screw or bolt. Accordingly, fastener 20 includes a driving portion 22 and a threaded shank 24. Driving portion 22, sometimes referred to as the head, includes an upper face 26 and a bottom face 28. A side wall 30 extends between upper face 26 and bottom face 28, thus establishing a thickness 32 of driving portion 22. Shank 24 extends from bottom face 28 and is integrally formed with driving portion 22. Shank 24 includes helical grooves or ridges, typically referred to as threads. Although shank 24 is illustrated with a generally blunt bottom, typically found in bolts, it should be understood that shank 24 may instead have a pointed bottom, as found in some screws.

A slot-type indentation, i.e., recess 34, extends into driving portion 22 from upper face 26. Additionally, recess 34 is oriented in a radial direction relative to a rotational axis 36 of fastener 20 and opens at side wall of 30 of driving portion 22. Thus, from a side view, recess 34 appears as a notch or cutout in upper face 26 and side wall 30 of driving portion 22. In this illustrative embodiment, recess 34 extends across an entire diameter of driving portion 22 to form a first recessed section 38 and a second recessed section 40 that open at two diametrically opposing locations in side wall 30.

In accordance with an embodiment, each of first and second recessed sections 38 and 40, respectively, includes a first wall 42 in spaced relation to, i.e., spaced apart from, a second wall 44. First wall 42 is inwardly angled to form a first wedge-shaped undercut 46 underlying upper face 26 of driving portion 22. Likewise, second wall 44 is inwardly angled to form a second wedge-shaped undercut 48 underlying upper face 26 of driving portion 22. As such, first and second undercuts 46 and 48, respectively, are recessed spaces under upper face 26 that when viewed in cross section appear to be triangular, hence wedge-shaped. This wedge-shaped feature of undercuts 46 and 48 is emphasized in FIG. 1 by dotted lines that delineate two sides of the wedge-shaped undercuts 46 and 48.

FIG. 2 shows a side view of a driving tool 50 engaged with driving portion 22 of fastener 20. Driving tool 50 may be a screwdriver or bit type apparatus that includes a head 52 configured to mate with recess 34. As shown, head 52 includes a first outwardly angled portion 54 and a second outwardly angled portion 56. First outwardly angled portion 54 includes a first side surface 58, and second outwardly angled portion 56 includes a second side surface 60. Angled portions 54 and 56 are triangular, or wedge-shaped, extension sections that conform to the shape of first and second wedge-shaped undercuts 46 and 48. However, a width 62 of head 52 may be narrower than a width 64 of recess 34.

In operation, head 52 of driving tool 50 can be inserted into recess 34 axially from upper face 26. Driving tool 50 can then be rotated to interlock head 52 of driving tool 50 with fastener 20. That is, height and depth dimensions of first and second undercuts 46 and 48 relative to first and second outwardly angled portions 54 and 56 of driving tool 50 are such that outwardly angled portions 54 and 56 may effectively interlock with respective wedge-shaped undercuts 46 and 48 when driving tool is rotated. For example, as driving tool 50 is rotated clockwise relative to rotational axis 36, first side surface 58 of first angled portion 54 will slide underneath and move into contact with first wall 42 of first wedge-shaped undercut 46 in each of first and second recessed sections 38 and 40. Likewise, as driving tool 50 is rotated counterclockwise relative rotational axis 36, second side surface 60 of second angled portion 56 will slide underneath and move into contact with second wall 44 of second wedge-shaped undercut 48 in each of first and second recessed sections 38 and 40.

The corresponding shape and sizes of undercuts 46 and 48 relative to outwardly angled portions 54 and 56 provides a reliable and releasable interlock between fastener 20 and driving tool 50 so that fastener 20 can be accessed by driving tool 50 when fastener 20 is in hidden locations and/or in a variety of angular orientations. Additionally, when driving tool 50 is interlocked with fastener 20, first side surface 58 of driving tool 50 engages substantially the entire surface area of first wall 42. Alternatively, second side surface 60 of driving tool 50 engages substantially the entire surface are of second wall 44. This provides a large surface area for the transfer of torque between driving tool 50 and fastener 20 which can substantially limit undue wear on and/or damage to either of fastener 20 and driving tool 50. Furthermore, during extraction of fastener 20, the contact between, for example, second wall 44 and second side surface 60 causes fastener 20 and driving tool 50 to be pulled together so that a user need not apply significant axial force in the direction opposite to the back out movement direction of the fastener. This results in a cooperative positive removal force between driving tool 50 and fastener 20.

A variety of alternative embodiments are described below to illustrate the wide variation of shapes, sizes, and purposes for fasteners that may be implemented. However, each of the fasteners described below and illustrated herein include the wedge-shaped undercut feature for the advantages discussed above in connection with fastener 20.

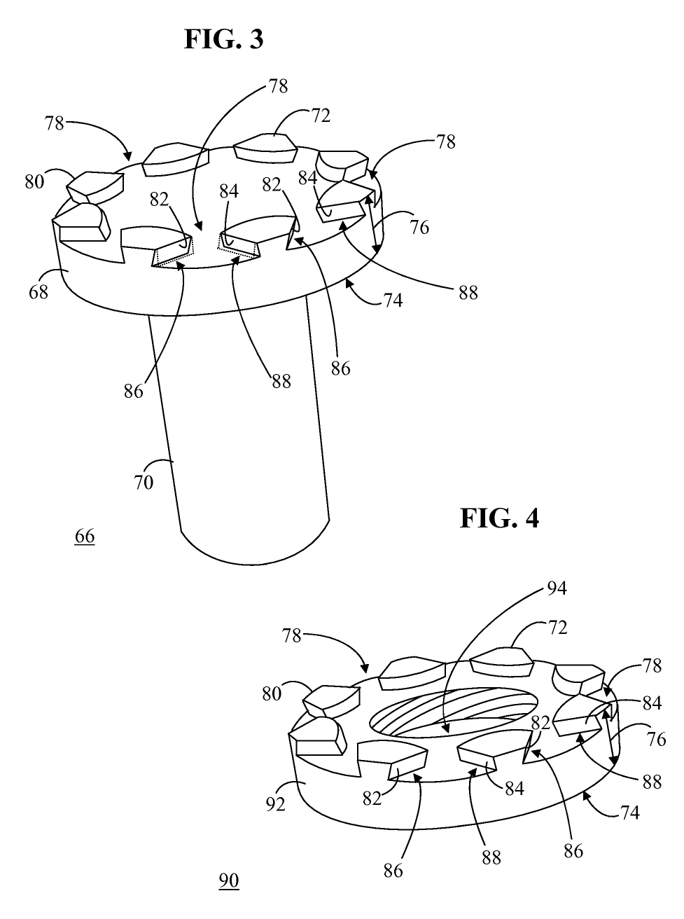

FIG. 3 shows a perspective view of a fastener 66 in accordance with another embodiment. Fastener 66 may be a screw or bolt, and therefore includes a driving portion 68 and a shank 70. Driving portion 68 includes an upper face 72, a bottom face 74, and a side wall 76 extending between upper face 72 and bottom face 74. Shank 70 is integrally formed with bottom face 74 of driving portion 68. Shank 70 is not illustrated with helical grooves or ridges, i.e., threads, around the outside like those shown in connection with fastener 20 (FIG. 1) for simplicity of illustration. It should be understood, however, that fastener 66 in the form of a screw or bolt typically includes threads.

Multiple recessed sections 78 extend into driving portion 68 from upper face 72 and open at side wall 76. Recessed sections 78 are symmetrically arranged about an outer perimeter 80 of upper face 72. The term “symmetrically arranged” refers to the substantially equal size, shape, and distribution of recessed sections 78 about outer perimeter 80. In the illustrated embodiment, the majority of upper face 72 is not present in order to form the multiplicity of recessed sections 78 about outer perimeter 80. Thus, from a side view, the remaining material of upper face 72 appears as multiple (e.g., eight) protrusions separated by recessed sections 78.

Each of recessed sections 78 includes a first wall 82 in spaced relation to, i.e., spaced apart from, a second wall 84. First wall 82 is inwardly angled to form a first wedge-shaped undercut 86 underlying upper face 72 of driving portion 68. Likewise, second wall 84 is inwardly angled to form a second wedge-shaped undercut 88 underlying upper face 72 of driving portion 68. As such, first and second undercuts 86 and 88, respectively, are recessed spaces under upper face 72 that when viewed in cross section appear to be triangular, hence wedge-shaped. Again, this wedge-shaped feature of undercuts 86 and 88 is emphasized in FIG. 3 by dotted lines that delineate two sides of the wedge-shaped undercuts 86 and 88.

A driving tool (not shown) includes a shape that is inverted from, i.e., opposite to, driving portion 68. Such a driving tool would have raised sections, i.e., protrusions, corresponding to recessed sections 78, the protrusions including the outwardly angled features capable of interlocking with wedge-shaped undercuts 86 and 88 of driving portion 68. Since fastener 66 includes multiple recessed sections 78, each having first and second wedge-shaped undercuts 86 and 88, a larger surface area than that of fastener 20 (FIG. 1) is provided for the transfer of torque between the driving tool and fastener 66 for increased interlocking capability, further decreasing the probability of damage to either of fastener 66 or the driving tool, and enabling the cooperative positive removal force between the driving tool and fastener 66.

FIG. 4 shows a perspective view of a fastener 90 in accordance with another embodiment. Previous embodiments were directed to screw or bolt type fasteners. However, the principles of the invention may be applied to a nut, i.e., a hardware fastener with a threaded hole that is typically used opposite a mating bolt to fasten parts together. Fastener 90 is an adaptation of the threaded screw-type fastener 66 (FIG. 3) into a nut configuration.

Fastener 90 includes a driving portion 92. Like driving portion 68 (FIG. 3) of fastener 66, driving portion 92 includes upper face 72, bottom face 74, and side wall 76 extending between upper face 72 and bottom face 74. Recessed sections 78 extend into driving portion 68 from upper face 72 and open at side wall 76, and each of recessed sections 78 includes first wall 82 having first wedge-shaped undercut 86 in spaced relation to second wall 84 having second wedge-shaped undercut 88. Fastener 90 does not include a shank. Instead, driving portion 92 includes a threaded hole 94 extending through the thickness of driving portion 92 through which a bolt may be mated in order to fasten parts together.

Fastener 90 in the form of a nut gains the advantages of the wedge-shaped undercuts as discussed above. Additionally, the same driving tool may be used to install or remove either of the screw-type fastener 66 (FIG. 3) or the nut-type fastener 90. This is in contrast to prior art hardware structures in which a screwdriver may be used to install or remove a screw, whereas a wrench is used to install or remove a typically hexagonally shaped nut. Furthermore, a wrench for a conventional nut typically encircles the outer walls of the nut.

Thus, such nuts must be located such that there is sufficient space around the nut to accommodate placement of the wrench. Since a driving tool interlocks with recessed sections 78 of nut-type fastener 90 extending inwardly from upper face 72, the driving tool head need not be greater in diameter than the diameter of fastener 90. Accordingly, such a fastener 90 can be utilized in small, difficult to access locations in which there is insufficient space around nut-type fastener 90 to accommodate placement of a wrench.

Fasteners 66 and 90 may be implemented in commercially available products, and users may have access to and/or own the appropriate driving tool. Alternatively, however, fasteners 66 and/or 90 may be implemented in commercially available products, but typical users may not have access to and/or own the appropriate driving tool. Under such a scenario, extraction and removal of fasteners 66 and 90 may be limited to specialized or authorized personnel for servicing or maintenance of particular hardware products.

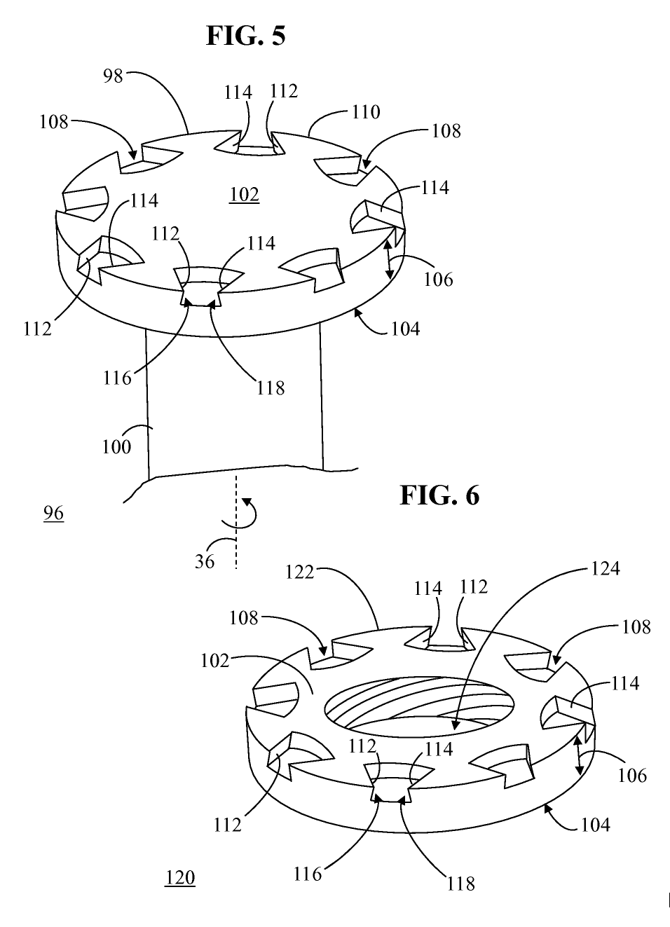

FIG. 5 shows a perspective view of a fastener 96 in accordance with another embodiment. Fastener 96 is illustrated to provide a configuration that is inverted relative to fastener 66 (FIG. 3). As such, fastener 96 includes a driving portion 98 and a shank 100. Driving portion 98 includes an upper face 102, a bottom face 104, and a side wall 106 extending between upper face 102 and bottom face 104. Shank 100 is integrally formed with bottom face 104 of driving portion 98. Shank 100 can include helical grooves or threads. However, threads are not shown herein for simplicity of illustration.

Multiple recessed sections 108 extend into driving portion 98 from upper face 102 and open at side wall 106. Recessed sections 108 are symmetrically arranged about an outer perimeter 110 of upper face 102. Each of recessed sections 108 includes a first wall 112 in spaced relation to, i.e., spaced apart from, a second wall 114. First wall 112 is inwardly angled to form a first wedge-shaped undercut 116 underlying upper face 102 of driving portion 98. Likewise, second wall 114 is inwardly angled to form a second wedge-shaped undercut 118 underlying upper face 102 of driving portion 98. As such, first and second undercuts 116 and 118, respectively, are recessed spaces under upper face 102 that when viewed in cross section appear to be triangular, hence wedge-shaped.

FIG. 6 shows a perspective view of a fastener 120 in accordance with another embodiment. Fastener 120 is an adaptation of the threaded screw-type fastener 96 (FIG. 5) into a nut configuration. Fastener 120 includes a driving portion 122. Like driving portion 98 (FIG. 5) of fastener 96, driving portion 122 includes upper face 102, bottom face 104, and side wall 106 extending between upper face 102 and bottom face 104. Recessed sections 108 extend into driving portion 122 from upper face 102 and open at side wall 106, and each of recessed sections 108 includes first wall 112 in spaced relation to second wall 114. Additionally, first wall 112 is angled to form first wedge-shaped undercut 116, and second wall 114 is angled to form second wedge-shaped undercut 118. Fastener 120 does not include a shank. Instead, driving portion 122 includes a threaded hole 124 extending through the thickness of driving portion 122 through which a bolt may be mated in order to fasten parts together.

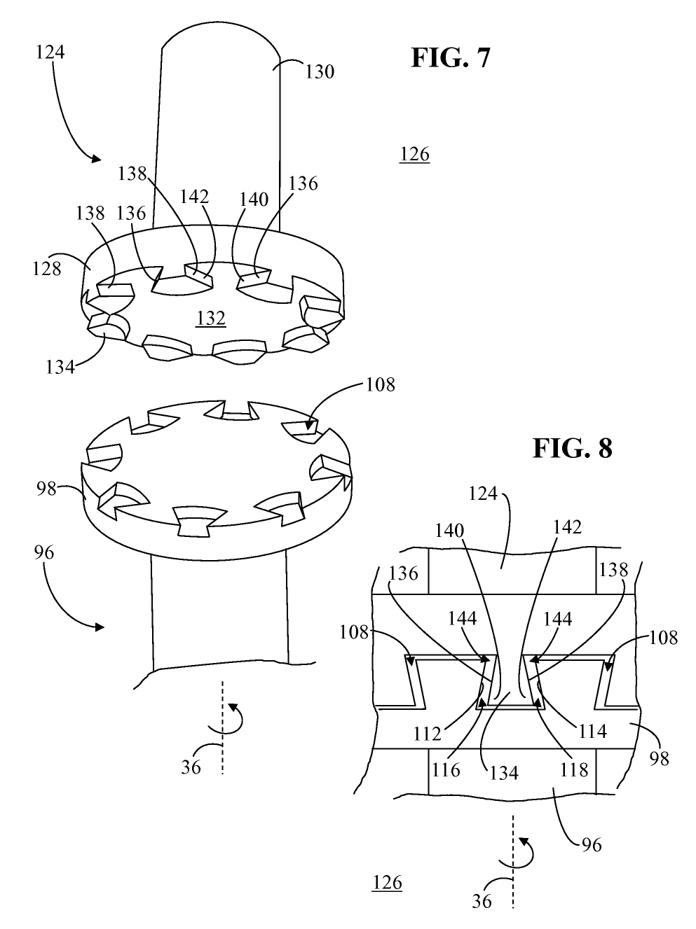

Referring to FIGS. 7 and 8, FIG. 7 shows a partial perspective view of a driving tool 124 configured to engage with fastener 96, and FIG. 8 shows an enlarged partial side view of driving tool 124 engaged with fastener 96. The combination of driving tool 124 and fastener 96 yields a fastening system 126 for coupling parts together, where fastening system 126 may be provided with a plurality of fasteners 96 and a single driving tool 124. In FIG. 7, driving tool 124 is illustrated in a slightly backwardly tilted position in order to reveal features of driving tool 124 capable of mating with fastener 96.

In an embodiment, driving tool 124 includes a head 128 coupled to a tool shaft 130. Head 128 has a floor 132 and raised sections 134, i.e., protrusions, extending from floor 132. Each of raised sections 134 includes a third wall 136 spaced apart from a fourth wall 138. Third wall 136 is angled relative to floor 132 to form a first wedge-shaped extension section 140. In an embodiment, fourth wall 138 may also be angled relative to floor 132 to form a second wedge-shaped extension section 142.

It should be noted that head 128 of driving tool 124 is described as having raised sections 134 with wedge-shaped extension sections 140 and 142. However, as most clearly illustrated in FIG. 8, undercuts 144 are produced underlying first and second wedge-shaped extension sections 140 and 142, respectively. Thus, the elements of head 128 of driving tool 124 correlate to the elements of driving portion 68 (FIG. 3) of fastener 66 (FIG. 3). Accordingly, tool shaft 130 is axially aligned with fastener 96 and can be rotated clockwise or counterclockwise to interlock head 128 of driving tool 124 with fastener 96, discussed below.

Wedge-shaped extension sections 140 and 142 are configured to mate or engage with drive portion 98 of fastener 96 by positioning raised sections 134 in corresponding recessed sections 108 of driving portion 98. That is, height and depth dimensions of first and second undercuts 116 and 118 relative to first and second wedge-shaped extension sections 140 and 142 of driving tool 124 are such that wedge-shaped extension sections 140 and 142 may effectively interlock with respective wedge-shaped undercuts 116 and 118 when driving tool 124 is rotated. For example, as driving tool 124 is rotated clockwise relative to rotational axis 36, third wall 136 of first extension section 140 will slide underneath and move into contact with first wall 112 of first wedge-shaped undercut 116 in each of recessed sections 108. Likewise, as driving tool 124 is rotated counterclockwise relative to rotational axis 36, fourth wall 138 of second extension section 142 will slide underneath and move into contact with second wall 114 of second wedge-shaped undercut 118 in each of first and second recessed sections 38 and 40.

The corresponding shape and sizes of undercuts 116 and 118 in relation to wedge-shaped extension sections 140 and 142 enables a reliable and releasable interlock capability, as well as enabling an effective transfer of torque between driving tool 124 and fastener 96 so as to limit damage to either of fastener 96 and driving tool 124 and driving tool, and enabling the cooperative positive removal force between the driving tool and fastener 66.

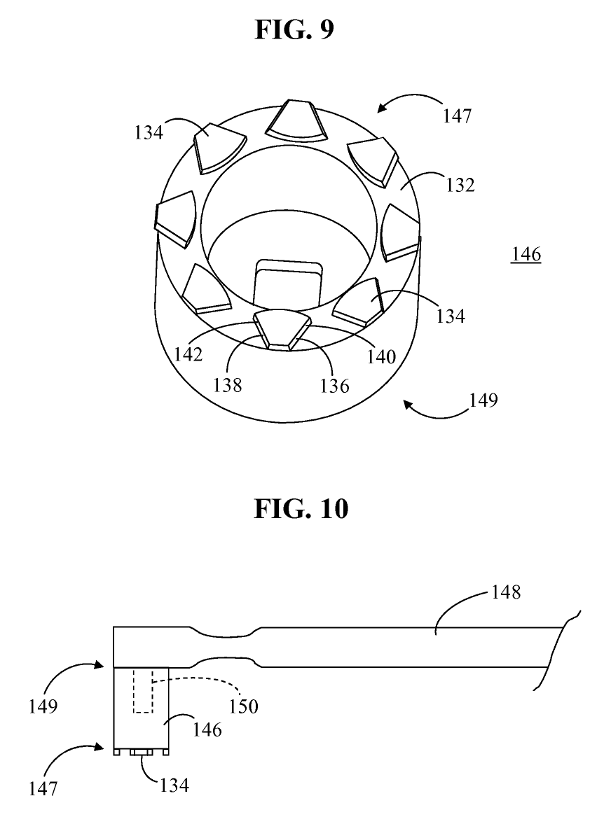

Referring to FIGS. 9 and 10, FIG. 9 shows a perspective view of a driving tool in the form of a socket 146 in accordance with another embodiment, and FIG. 10 shows a side view of socket 146 engaged with a ratchet type wrench handle 148. Socket 146 does not have the conventional cup-shaped fitting with a recess that grips the head of a bolt. Instead, socket 146 has a similar profile to head 128 (FIG. 7) of driving tool 124 (FIG. 7). Thus, a first end 147 of socket 146 includes floor 132 and raised sections 134 extending from floor 132. Each of raised sections 134 includes third wall 136 spaced apart from fourth wall 138, where third wall 136 is angled to yield first wedge-shaped extension section 140, and fourth wall 138 is angled to yield second wedge-shaped extension section 142. First and second wedge-shaped extension sections 140 and 142 are configured to mate with respective wedge-shaped undercuts 116 and 118 (FIG. 5) of fastener 96 (FIG. 5) as discussed in detail in connection with FIGS. 7 and 8.

A second end 149 of socket 146 snaps onto a male fitting 150 (shown in dashed line form in FIG. 10) on wrench handle 148. The driving tool, i.e., socket 146, is axially aligned with fastener 96 when it is interlocked with driving portion 98 (FIG. 5) of fastener 96. However, handle 148 provides the torque to turn socket 146 so as to install or extract fastener 96.

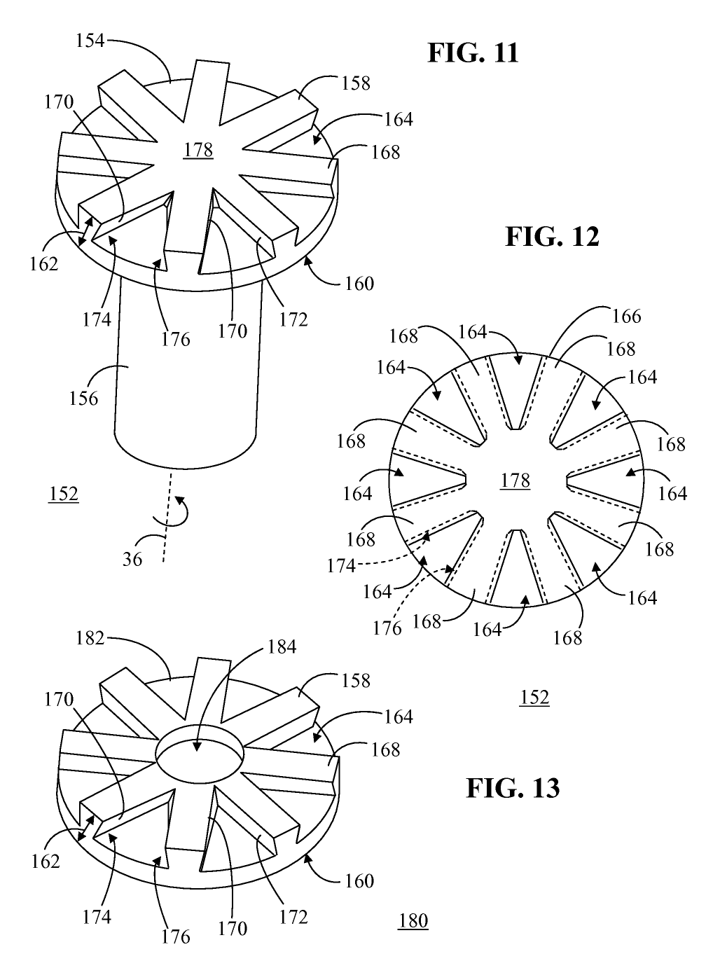

Referring to FIGS. 11 and 12, FIG. 11 shows a perspective view of a fastener 152 in accordance with another embodiment, and FIG. 12 shows a top view of fastener 152. Fastener 152 may be a screw or bolt, and therefore includes a driving portion 154 and a shank 156 integrally formed with driving portion 154, which may be threaded. Driving portion 154 includes an upper face 158, a bottom face 160, and a side wall 162 extending between upper face 158 and bottom face 160.

Multiple recessed sections 164 extend into driving portion 154 from upper face 158 and open at side wall 162. Recessed sections 164 are symmetrically arranged about an outer perimeter of upper face 158, and are oriented in a direction substantially perpendicular to rotational axis 36. In the illustrated embodiment, recessed sections 164 are approximately triangular in shape. Thus, as visible in the top view of FIG. 12, the remaining material of upper face 158 appears as multiple radially extending arms 168 (e.g., eight) separated by recessed sections 164. That is, arms 168 are oriented in a radial direction relative to the center of fastener 152, i.e., rotational axis 36.

Each of recessed sections 164 includes a first wall 170 in spaced relation to, i.e., spaced apart from, a second wall 172. First wall 170 is inwardly angled to form a first wedge-shaped undercut 174 underlying upper face 158 of driving portion 154. Likewise, second wall 172 is inwardly angled to form a second wedge-shaped undercut 176 underlying upper face 158 of driving portion 154. As such, first and second undercuts 174 and 176, respectively, are recessed spaces under upper face 158 that when viewed in cross section appear to be triangular, hence wedge-shaped. First and second undercuts 174 and 176 are represented in the top view of FIG. 12 by hidden lines underlying arms 168.

Since fastener 152 includes multiple recessed sections 164, each having first and second wedge-shaped undercuts 174 and 176, a relatively large contact surface area is provided for enhanced interlocking capability and to facilitate the transfer of torque between the driving tool and fastener 152, thereby enabling the cooperative positive removal force between the driving tool and fastener 152 as well as decreasing the probability of damage to either of fastener 152 or the driving tool. Fastener 152 achieves additional benefits as well. In particular, fastener 152 may be formed with a backward compatibility option in which a central region 178 of upper face 158 can be used to add, for example, a conventional phillips, slotted, allen pattern, and so forth so that fastener 152 may be used with multiple driving tools.

A driving tool (not shown) includes a shape that is inverted from, i.e., opposite to, driving portion 154 of fastener 152. Such a driving tool would have raised sections, i.e., protrusions, corresponding to recessed sections 164, the protrusions including the outwardly angled features capable of interlocking with wedge-shaped undercuts 174 and 176 of driving portion 154. In some embodiments, the protrusions of the driving tool may be relatively shallow and/or the protrusions may be made with materials that are weaker than the hardness of the driving tool. This configuration can enable the protrusions of the driving tool to shear prior to stripping driving portion 154 of fastener 152.

FIG. 13 shows a perspective view of a fastener 180 in accordance with another embodiment. Fastener 180 is an adaptation of the threaded screw-type fastener 152 (FIG. 10) into a nut configuration. Fastener 180 includes a driving portion 182. Like driving portion 154 (FIG. 10) of fastener 152, driving portion 182 includes upper face 158, bottom face 160, and side wall 162 extending between upper face 158 and bottom face 160. Recessed sections 164 extend into driving portion 182 from upper face 158 and open at side wall 162, and each of recessed sections 164 includes first wall 170 having first wedge-shaped undercut 174 in spaced relation to second wall 172 having second wedge-shaped undercut 176. Fastener 180 does not include a shank. Instead, driving portion 182 includes a threaded hole 184 extending through the thickness of driving portion 182 through which a bolt may be mated in order to fasten parts together.

Fastener 180 in the form of a nut gains the advantages of the wedge-shaped undercuts as discussed above. Additionally, the same driving tool may be used to install or remove either of the screw-type fastener 152 (FIG. 11) or the nut-type fastener 180. This style of driving tool removes the need for a wrench that typically encircles the outer walls of the nut, so that fastener 180 can be utilized in small, difficult to access locations in which there is insufficient space around nut-type fastener 180 to accommodate placement of a wrench. Fastener 180, as well as the previously discussed nut-type fasteners can achieve additional benefits as well. In particular, fastener 180 may be formed to further include recessed sections 164 and arms 168 on bottom face 160. With such a configuration in which recessed sections 164 and arms 168 are located on both upper face 158 and bottom face 160 of a nut-type fastener, two such fasteners can be utilized back-to-back to mate, or interlock, with one another.

Like the previously discussed fasteners, fasteners 152 and 180 may be implemented in commercially available products, and users may have access to and/or own the appropriate driving tool. Alternatively, however, fasteners 152 and/or 180 may be implemented in commercially available products, but typical users may not have access to and/or own the appropriate driving tool. Under such a scenario, installation and extraction of fasteners 152 and 180 may be limited to specialized or authorized personnel for servicing or maintenance of particular hardware products.

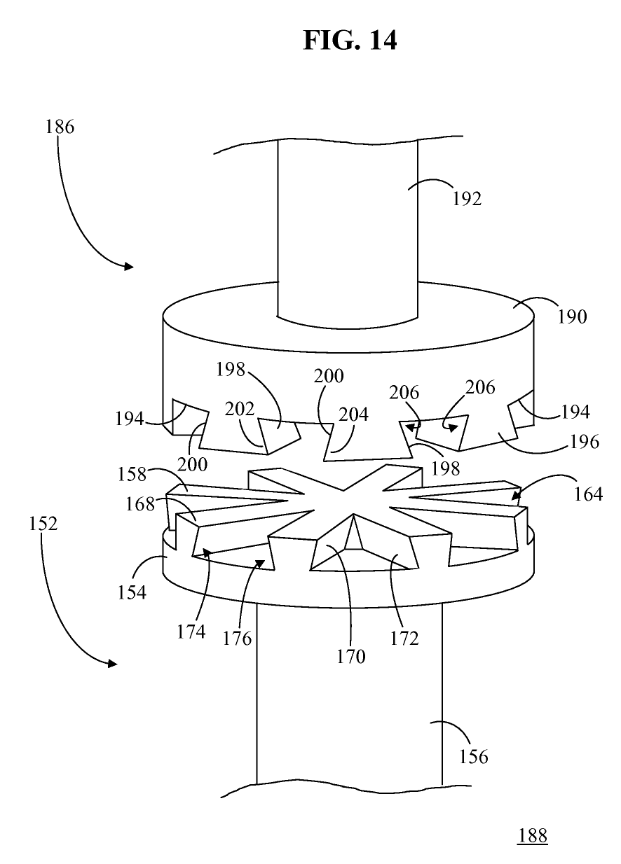

FIG. 14 shows a perspective view of a driving tool 186 configured to engage with fastener 152. The combination of driving tool 186 and fastener 152 yields a fastening system 188 for coupling parts together, where fastening system 188 may be provided with a plurality of fasteners 152 and a single driving tool 186. In an embodiment, driving tool 186 includes a head 190 coupled to a tool shaft 192. Head 190 has a floor 194 and raised sections 196, i.e., protrusions, extending from floor 194. Each of raised sections 196 includes a third wall 198 spaced apart from a fourth wall 200. Third wall 198 is angled relative to floor 194 to form a first wedge-shaped extension section 202. In an embodiment, fourth wall 200 may also be angled relative to floor 194 to form a second wedge-shaped extension section 204. It should be noted that head 190 of driving tool 186 is described as having raised sections 196 with wedge-shaped extension sections 202 and 204. However, as shown in FIG. 14, undercuts 206 are produced underlying first and second wedge-shaped extension sections 202 and 204, respectively. Thus, the elements of head 190 of driving tool 186 are the inverse of the elements of fastener 152. Tool shaft 192 is axially aligned with fastener 152 and can be rotated clockwise or counterclockwise to interlock head 190 of driving tool 186 with fastener 152.

Wedge-shaped extension sections 202 and 204 are configured to mate or engage with driving portion 154 of fastener 152 by positioning raised sections 196 in corresponding recessed sections 164 of driving portion 154. That is, height and depth dimensions of first and second undercuts 174 and 176 relative to first and second wedge-shaped extension sections 202 and 204 of driving tool 186 are such that wedge-shaped extension sections 202 and 204 may effectively interlock with respective wedge-shaped undercuts 174 and 176 when driving tool 186 is rotated. The corresponding shape and sizes of undercuts 174 and 176 in relation to wedge-shaped extension sections 202 and 204 enables a reliable and releasable interlock capability, as well as enabling an effective transfer of torque between driving tool 186 and fastener 152 so as to limit damage to either of fastener 152 and driving tool 186 and to enable the cooperative positive removal force between driving tool 186 and fastener 152.

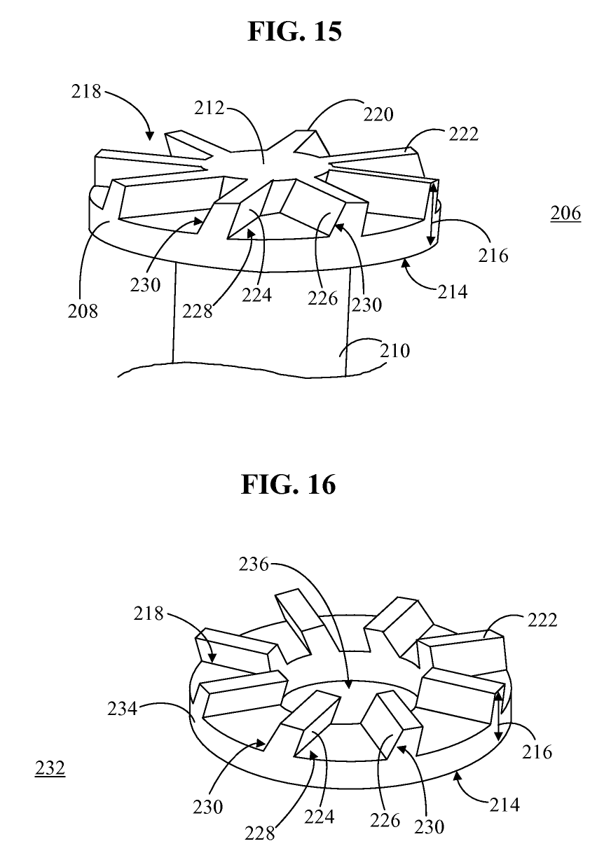

FIG. 15 shows a partial perspective view of a fastener 206 in accordance with another embodiment. Some security situations may call for a one way, or tamper-resistant, application. This type of fastener is sometimes referred to as a one way bolt, security fastener, tamper-resistant fastener, and the like. A one way bolt is a screw-type fastener that once installed cannot be readily removed, i.e., “unscrewed,” due to its physical configuration. The physical configuration of fastener 206 enables it to be utilized in a one way bolt application.

Fastener 206 may be a screw or bolt, and therefore includes a driving portion 208 and a threaded shank 210 integrally formed with driving portion 208. Driving portion 208 includes an upper face 212, a bottom face 214, and a side wall 216 extending between upper face 212 and bottom face 214. Multiple recessed sections 218 extend into driving portion 208 from upper face 212 and open at side wall 216. Recessed sections 218 are symmetrically arranged about an outer perimeter of upper face 212. In the illustrated embodiment, recessed sections 218 are approximately triangular in shape. Thus, as visible in FIG. 15, the remaining material of upper face 212 appears as multiple radially extending arms 222 (e.g., eight) separated by recessed sections 218.

Each of recessed sections 218 includes a first wall 224 in spaced relation to, i.e., spaced apart from, a second wall 226. First wall 224 is inwardly angled to form a wedge-shaped undercut 228 underlying upper face 212 of driving portion 208. However, in accordance with the security bolt application embodiment, second wall 226 is outwardly angled to form a ramped section 230. Wedge-shaped undercut 228 is formed in the installation direction of fastener 206, and ramped section 230 is formed in the removal direction side of driving portion 208. Accordingly, rotation of fastener 206 in the direction of installation results in corresponding protrusions of a driving tool (not shown) interlocking with wedge-shaped undercut 228 in each of recessed sections 218. However, if an attempt is made to rotate fastener 206 in the opposite direction, i.e., the removal direction, a driving tool cannot effectively interlock with ramped section 230. That is, the driving tool will slide off of ramped section 230 so as to prevent the ready extraction of fastener 206.

FIG. 16 shows a perspective view of a fastener 232 in accordance with another embodiment. Fastener 232 is an adaptation of the threaded security bolt fastener 206 (FIG. 15) into a security nut configuration. Fastener 232 includes a driving portion 234. Driving portion 234 includes all of the features of driving portion 208 (FIG. 15) of fastener 206 including especially recessed sections 218 having both wedge-shaped undercut 228 and ramped section 230. The remaining elements will not be reiterated herein for brevity. In accordance with the nut configuration, driving portion 234 includes a threaded hole 236 extending through the thickness of driving portion 234 through which a bolt (not shown) may be mated in order to fasten parts together.

Fastener 232 in the form of a nut gains the advantages of the wedge-shaped undercuts to facilitate installation, as discussed above. However, if an attempt is made to rotate fastener 232 in a removal direction, a driving tool cannot effectively interlock with ramped section 230. That is, the driving tool will slide off of ramped section 230 so as to prevent the ready extraction of fastener 232.

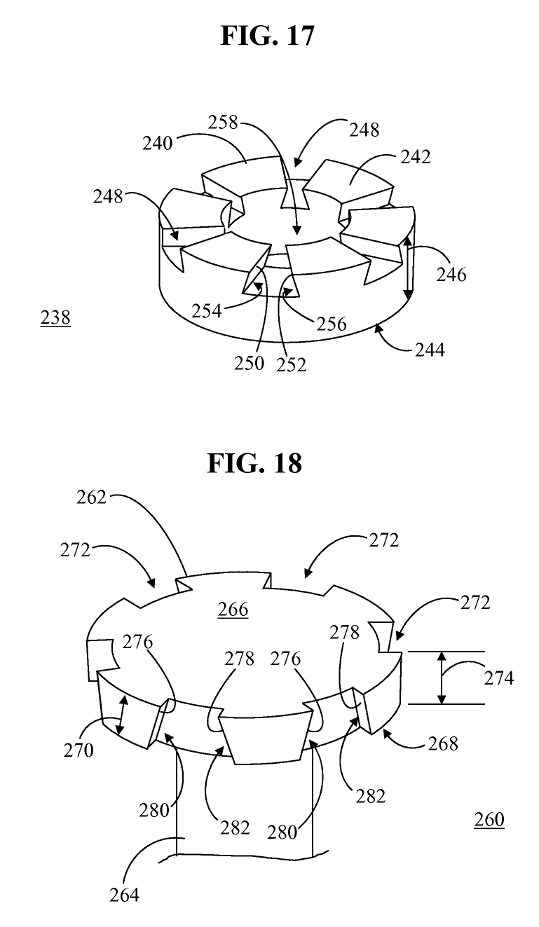

FIG. 17 shows a perspective view of a fastener 238 in accordance with yet another embodiment. Fastener 238 is a crown style nut, also referred to as a slotted nut. A crown nut (aka slotted nut) is typically used in conjunction with a cotter pin on a drilled shank fastener to prevent loosening.

Fastener 238 includes a driving portion 240. Like previous embodiments, driving portion 240 includes an upper face 242, a bottom face 244, and a side wall 246 extending between upper face 242 and bottom face 244. Recessed sections 248 extend into driving portion 240 from upper face 242 and open at side wall 246. Each of recessed sections 248 includes a first wall 250 in spaced relation to a second wall 252. First wall 250 is inwardly angled to form a first wedge-shaped undercut 254 underlying upper face 242. Likewise, second wall 252 is inwardly angled to form a second wedge-shaped undercut 256 underlying upper face 240. Fastener 238 further includes a threaded hole 258 extending through the thickness of driving portion 240 through which a bolt may be mated in order to fasten parts together.

Fastener 238 in the form of a crown style nut gains the advantages of the wedge-shaped undercuts for installation and extraction, as discussed above. However, a driving tool (not shown) interlocks with recessed sections 248 of crown style fastener 238 extending inwardly from upper face 242. Thus, the driving tool head need not be greater in diameter than the diameter of fastener 234. This is in contrast to the use of a wrench type driving tool used to install or remove a typically hexagonally shaped nut. Accordingly, such a fastener 238 can be utilized in difficult to access locations in which there is insufficient space around nut-type fastener 238 to accommodate placement of a conventional wrench.

FIG. 18 shows a partial perspective view of a fastener 260 in accordance with another embodiment. Fastener 260 allows both torque increases as well as the cooperative positive removal force which causes the driving tool and the face of the fastener to be pulled together. In the illustrated embodiment, fastener 260 includes a driving portion 262 and a threaded shank 264. Driving portion 262 includes an upper face 266, a bottom face 268, and a side wall 270 extending between upper face 266 and bottom face 268. Shank 264 is integrally formed with driving portion 262 and extends from bottom face 268.

Recessed sections 272 extend into driving portion 262 from upper face 266 and open at side wall 270. In accordance with an embodiment, each of recessed sections 272 extends through an entire thickness 274 of driving portion 262 from upper face 266 through bottom face 268. Each of recessed sections 272 includes a first wall 276 in spaced relation to a second wall 278. First wall 276 is inwardly angled to form a first wedge-shaped undercut 280 underlying upper face 266. Likewise, second wall 278 is inwardly angled to form a second wedge-shaped undercut 282 underlying upper face 266. Greater torque increases may be achieved using fastener 260 because recessed sections 272 extend through the entire thickness 274 of driving portion 262.

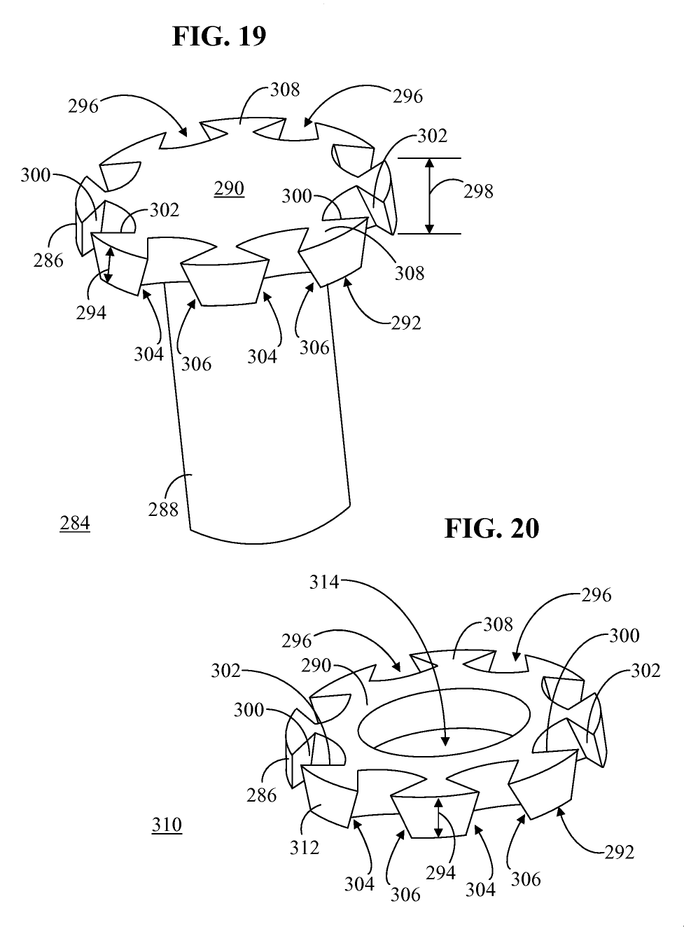

FIG. 19 shows a perspective view of a fastener 284 in accordance with another embodiment. Fastener 284 is a one way bolt, or security fastener, in accordance with another embodiment. Fastener 284 may be a screw or bolt, and therefore includes a driving portion 286 and a threaded shank 288 integrally formed with driving portion 286. Driving portion 286 includes an upper face 290, a bottom face 292, and a side wall 294 extending between upper face 290 and bottom face 292. Multiple recessed sections 296 extend into driving portion 286 from upper face 290 and open at side wall 294. Recessed sections 296 are symmetrically arranged about an outer perimeter of upper face 290.

In accordance with an embodiment, each of recessed sections 296 extends through an entire thickness 298 of driving portion 286 from upper face 290 through bottom face 292. Each of recessed sections 296 includes a first wall 300 in spaced relation to a second wall 302. First wall 300 is inwardly angled to form a first wedge-shaped undercut 304 underlying upper face 290. Likewise, second wall 302 is inwardly angled to form a second wedge-shaped undercut 306 underlying upper face 290. Fastener 284 further includes a shear element 308 positioned between pairs of recessed sections 296. More particularly, the material section of driving portion 286 positioned between the pairs of recessed sections 296 forms shear element 308.

Like the aforementioned fasteners, fastener 284 includes wedge-shaped undercuts 304 and 306 for enhanced interlocking capability and to facilitate the transfer of torque between a driving tool (not shown) and fastener 284. In addition, and particular to the utilization of fastener 284 in a one way security application, rotation of fastener 284 in the direction of installation results in corresponding protrusions of the driving tool interlocking with the corresponding undercut, for example, first wedge-shaped undercut 304, in each of recessed sections 296 of driving portion 286. However, once fastener 284 has been tightened to a predetermined, designed, torque value, shear elements 308 will shear, or break off, in response to the shear stress. Consequently, once installed, fastener 284 cannot be readily removed due to the absence of shear elements 308 because a driving tool can no longer effectively interlock with driving portion 286.

FIG. 20 shows a perspective view of a fastener 310 in accordance with yet another embodiment. Fastener 310 is an adaptation of the threaded security bolt fastener 284 (FIG. 19) into a security nut configuration. Fastener 310 includes a driving portion 312. Driving portion 312 includes all of the features of driving portion 286 (FIG. 19) of fastener 284 including especially recessed sections 296 having first and second wedge-shaped undercuts 304 and 306, respectively, and shear elements 308. The remaining elements will not be reiterated herein for brevity. In accordance with the nut configuration, driving portion 312 includes a threaded hole 314 extending through the thickness of driving portion 312 through which a bolt (not shown) may be mated in order to fasten parts together.

Fastener 310 in the form of a nut gains the advantages of the wedge-shaped undercuts 304 and 306 to facilitate installation, as discussed above. However, once fastener 310 is installed and shear elements 308 have been broken, or sheared, off, a driving tool cannot effectively interlock with fastener 310 in order to remove it due to the absence of shear elements 308.

In summary, embodiments entail a variety of fasteners, each of which includes at least one recessed section extending into a driving portion of the fastener, and each recessed section including a wedge-shaped undercut feature. A driving tool is configured to engage, or mate, with a corresponding wedge-shaped undercut feature of a particular fastener. Engagement of the driving tool with the fastener causes the driving portion of the fastener to temporarily interlock with the driving tool. This interlocking feature reduces the probability of stripping, increases the amount of torque that may be applied, can be implemented in low profile applications and/security fastener applications, and so forth. During extraction of the fastener in some embodiments, engagement of the driving tool with the fastener results in a cooperative application force which causes the driving tool and the face of the fastener to be pulled together to facilitate removal and to decrease the probability of damaging the fastener and/or driving tool.

Although the preferred embodiments of the invention have been illustrated and described in detail, it will be readily apparent to those skilled in the art that various modifications may be made therein without departing from the spirit of the invention or from the scope of the appended claims. In particular, the wedge-shaped undercut feature can be implemented in a wide variety of shapes and styles of fasteners, such as screws, bolts, nuts, and so forth.

What is claimed is:

1. A fastener comprising:
a driving portion having an upper face; and
at least one recessed section extending into said driving portion from said upper face, said recessed section including a first wall in spaced relation to a second wall, said first wall being angled to form a wedge-shaped undercut underlying said upper face of said driving portion.

2. A fastener as claimed in claim 1 said wedge-shaped undercut is a first wedge-shaped undercut, and said second wall is angled to form a second wedge-shaped undercut underlying said upper face of said driving portion.

3. A fastener as claimed in claim 1 wherein said driving portion comprises:
a bottom face; and
a side wall extending between said top face and said bottom face, and said at least one recessed section is oriented in a direction substantially perpendicular to a rotational axis of said fastener and opens at said side wall of said driving portion.

4. A fastener as claimed in claim 1 wherein said at least one recessed section is located at an outer perimeter of said upper face.

5. A fastener as claimed in claim 1 wherein:
said driving portion includes a bottom face and a side wall extending between said top face and said bottom face; and
said fastener further comprises multiple recessed sections extending into said driving portion from said upper face, said at least one recessed section being one of said multiple recessed sections, wherein each of said multiple recessed sections includes said first wall in spaced relation to said second wall, said first wall being angled to form said wedge-shaped undercut underlying said upper face of said driving portion, and said each of said recessed sections being symmetrically arranged about an outer perimeter of said upper face and opening at said side wall of said driving portion.

6. A fastener as claimed in claim 1 wherein said driving portion includes a bottom face and a side wall extending between said top face and said bottom face, said driving portion exhibiting a thickness between said top and bottom faces, and said at least one recessed section extends through said thickness of said driving portion from said upper face to said bottom face.

7. A fastener as claimed in claim 6 wherein:
said at least one recessed section is a first recessed section;
said fastener further comprises a second recessed section extending into said driving portion and extending through said thickness of said driving portion from said upper face to said bottom face, said first and second recessed sections being located at an outer perimeter of said upper face; and
said driving portion includes a shear element positioned between said first and second recessed sections, said shear element being configured to break upon application of a shear stress to said driving portion.

8. A fastener as claimed in claim 1 further comprising a shank integrally formed with said driving portion.

9. A fastener as claimed in claim 8 wherein said shank is a threaded shank.

10. A fastener as claimed in claim 1 wherein said driving portion further includes a threaded opening extending axially through said driving portion.

11. A fastener as claimed in claim 1 wherein said driving portion is configured to mate with a driving tool.

12. A fastening system comprising:
a fastener, said fastener including:
a driving portion having an upper face, a bottom face, and a side wall extending between said top face and said bottom face; and
at least one recessed section extending into said driving portion from said upper face, said at least one recessed section opening at said side wall of said driving portion, said at least one recessed section including a first wall in spaced relation to a second wall, said first wall being angled to form a wedge-shaped undercut underlying said upper face of said driving portion; and
a driving tool, said driving tool including a head, said head having a floor portion and a raised section extending from said floor, said raised section including a third wall spaced apart from a fourth wall, said third wall being angled relative to said floor of said driving tool to form a wedge-shaped extension section and configured to mate with said wedge-shaped undercut of said fastener.

13. A fastening system as claimed in claim 12 wherein said driving tool includes a tool shaft, said tool shaft being axially aligned with said fastener to impart torque on said fastener when said wedge-shaped extension section of said driving tool is mated with said wedge-shaped undercut of said fastener.

14. A fastening system as claimed in claim 12 wherein said driving tool comprises:
a barrel-shaped socket having a first end and a second end, said wedge-shaped extension section being formed in said first end; and
a drive handle configured to mate with said second end of said socket.

15. A fastening system as claimed in claim 12 wherein:
said fastener further includes multiple recessed sections extending into said driving portion from said upper face, said at least one recessed section being one of said multiple recessed sections, wherein each of said multiple recessed sections includes said first wall in spaced relation to said second wall, said first wall being angled to form said wedge-shaped undercut underlying said upper face of said driving portion, and said each of said recessed sections being symmetrically arranged about an outer perimeter of said upper face and opening at said side wall of said driving portion; and
said driving tool further includes multiple raised sections extending from said floor portion and corresponding to said multiple recessed sections, said raised section being one of said multiple raised section, wherein each of said multiple raised sections includes said third wall spaced apart from said fourth wall, said third wall being angled relative to said floor of said driving tool to form said wedge-shaped extension section outwardly extending from said third wall and configured to mate with said wedge-shaped undercut of said fastener.

16. A fastening system as claimed in claim 12 wherein:
said at least one recessed section is a first recessed section;
said fastener further comprises a second recessed section extending into said driving portion and extending through said thickness of said driving portion from said upper face to said bottom face, said first and second recessed sections being located at an outer perimeter of said upper face, and each of said first and second recessed sections extending through a thickness of said driving portion between said top and bottom faces; and
said driving portion includes a shear element positioned between said first and second recessed sections, said shear element being configured to break upon application of a shear stress to said driving portion, said shear stress being applied via said driving tool.

17. A fastener comprising:
a driving portion having an upper face, a bottom face, and a side wall extending between said top face and said bottom face; and
at least one recessed section extending into said driving portion from said upper face, said at least one recessed section being located at an outer perimeter of said upper face and opening at said side wall of said driving portion, said recessed section including a first wall in spaced relation to a second wall, said first wall being angled to form a first wedge-shaped undercut underlying said upper face of said driving portion, and said second wall is angled to form a second wedge-shaped undercut underlying said upper face of said driving portion.

18. A fastener as claimed in claim 17 further comprising multiple recessed sections extending into said driving portion from said upper face, said at least one recessed section being one of said multiple recessed sections, wherein each of said multiple recessed sections includes said first wall in spaced relation to said second wall, said first wall being angled to form said first wedge-shaped undercut underlying said upper face of said driving portion, said second wall being angle to form said second wedge-shaped undercut underlying said upper face of said driving portion.

19. A fastener as claimed in claim 18 wherein said each of said recessed sections are symmetrically arranged about said outer perimeter of said upper face and opening at said side wall of said driving portion.

20. A fastener as claimed in claim 18 wherein said driving portion includes a shear element positioned between each of said recessed sections, said shear element being configured to break upon application of a shear stress to said driving portion.
